(19) United States
(12) Patent Application Publication
(10) Pub. No.: US 2019/0277059 A1
(43) Pub. Date: Sep. 12, 2019

(54) Wireless Deadbolt Door Lock

(71) Applicant: Glen A. Robertson, Madison, AL (US)

(72) Inventor: Glen A. Robertson, Madison, AL (US)

(21) Appl. No.: 15/914,853

(22) Filed: Mar. 7, 2018

(51) Int. Cl. E05B 47/00

(52) U.S. Cl. CPC E05B 47/004; E05B 2047/0058; E05B 2047/0081; E05B 2047/0097; E05B 2047/0066

(57) ABSTRACT

A wireless deadbolt door lock is an electric dock lock that can be powered and controlled through wireless means. This is accomplished using an electric deadbolt door lock body containing a Dual Position Latching Solenoid (DPLS) to move a deadbolt plunger in a reciprocating linear motion, between a withdrawn deadbolt position and a locking deadbolt position, protruding out from the electric deadbolt door lock body. The DPLS is controlled by an energy efficient bi-stable permanent magnet activation system (BSPMAS), which can be wirelessly controlled. A wireless charging station between the door frame and the door can be used to charge batteries or capacitors to power the BSPMAS. A mechanical release/locking device and electrical mechanical switches are also provided for unlocking or locking the deadbolt door lock when a wireless device is unavailable.

### FIELD OF TECHNOLOGY

This invention relates to an electric deadbolt door lock that can be wirelessly powered and controlled, comprising an electric door lock body for attachment in a door containing: a Dual Position Latching Solenoid (DPLS) to move a deadbolt plunger in a reciprocating linear manner between a withdrawn deadbolt position and a locking deadbolt position, protruding out from the electric door locking body and into a locking mechanism attached in the door frame; a control circuit having a wireless control module to remotely operate the DPLS; and a wireless charging station between the door frame and the door to maintain a charge on a battery or capacitor that stores the energy needed to power the control circuit and activate the DPLS. A mechanical release/locking device and electrical mechanical switches are also provided for unlocking or locking the deadbolt door lock when a wireless device or power is unavailable.

### BACKGROUND ART

An electrically controlled door lock often uses a solenoid to control a deadbolting means in a door lock body as to hold a plunger into a frame about the door; placing the door lock in a deadbolt locked position. In the deadbolt locked position, the plunger is out; in other words, protruding out from the door lock body and into the frame about a door. The solenoid is also used to release the plunger from the deadbolt locked position, which allows the plunger to move into the door lock body, that is, to be withdrawn from the frame and placed in a deadbolt unlocked position.

In prior art solutions, the solenoid is functionally linked to the plunger so that it locks the plunger in the deadbolt locked position. In a typical implementation, the plunger is linked to the solenoid shaft, and a spring is used to arrange the shaft to extrude outwards from the solenoid. When the solenoid is de-energized, the spring holds the plunger in the deadbolt locked position, and when the solenoid is energized, the solenoid tries to move the plunger out of the deadbolt locked position against the spring force; placing it in the deadbolt unlocked position. The spring must be sufficiently strong to hold the plunger securely in the deadbolt locked position. This, in tum, means that the solenoid must be sufficiently powerful to be able to move the plunger against the spring force.

Another way of implementation is that the door lock is locked with the plunger in the deadbolt locked position when the solenoid is energized, compressing the spring force. When the solenoid is de-energized, the plunger is released by the spring force; placing it in a deadbolt unlocked position.

As such, the solenoid is either activated (under power) when the plunger is in the deadbolt locking position or in the deadbolt unlocked position. The choice of which case to use is typically dependent on security failsafe (locked or unlocked during power failure) and overall power consumption (how long the door is open or closed).

In today's more energy efficient homes and buildings, long term activation of such prior art solenoid solutions in a door lock, can over time become a major energy draw for the home or building's power management system. Thus, a need has arisen for an electric deadbolt door lock to be unpowered during both the locked and unlocked deadbolting positions to eliminate continuous power draw on the home or building's power management system.

Further, home and building power management systems are increasingly converting to green energy, as solar power, to reduce the carbon foot-print of the home or building. Green energy mechanisms typically have low power inputs that either have to be stored over time before power conversion can be made or the green energy systems have to be large, both can be complex. Thus, a need has arisen for an electric deadbolt door lock to be powered and controlled by a power versatile circuit to reduce the complexity of the green energy system used by the home or building's power management system.

Still further, providing power to an electric deadbolt door lock across an electrical wire from the frame to the door can over time prove cumbersome as well as dangerous. Thus, a need has risen for an electric deadbolt door lock to be powered through wireless means.

Even further, in today's smart-phone and wireless internet sociality more and more electrical devices are converting to wireless operation. Thus, a need has risen for an electric deadbolt door lock to be wirelessly controlled.

### SUMMARY OF THE INVENTION

In accordance with the present invention, an electric deadbolt door lock is provided that is: energy efficient for substantially reducing the continuous power draw on a home or building's power management system by having a solenoid that is unpowered between the lock and unlock activations, is power versatile for green energy application, can be wirelessly powered, and can be wirelessly operated. Such is accomplished through the use of a Dual Position Latching Solenoid (DPLS), a wireless controlled Energy Efficient Bi-Stable Permanent Magnet Activation System (BSPMAS) that is power versatile, and a wireless charging station to charge batteries or capacitors to power the electric deadbolt door lock.

A DPLS is a permanent magnet solenoid with two magnetic latching positions. Several versions of a DPLS can be produced all having similarity to U.S. Pat. No. 3,022,450. The differences generally being the design of the moveable magnetic latching portion of the DPLS. The preferred DPLS in the present invention has a magnetic housing containing a permanent magnet and one or more control coils placed about a moveable central core that is free to move between the ends of the housing. The one or more control coils are composed of multiple coils for use with the BSPMAS in the present invention, as is discussed in U.S. Pat. No. 9,343,216.

The permanent magnet's placement is at the center of the DPLS with the one or more control coils place adjacent to the permanent magnet. In the DPLS of the present invention, the magnetic flux from the permanent magnet is in a bi-stable state through the moveable central core and either end of the magnetic housing. By switching a pulse of current in one of two directions through the one or more of the control coils, more magnetic flux can be diverted in one direction through the moveable central core than the other, to either increase or decrease the magnetic force toward one end of the magnetic housing; causing the moveable central core to move in the direction of the higher magnetic force. Reversing the current then causes the moveable central core to move in the opposite direction. The permanent magnet in the DPLS then allows for holding the moveable central core against the magnetic housing in either of the two directions under no power verse the continuous power application done in prior art solenoids. Where by attaching the moveable central core to a deadbolt plunger, an electric deadbolt door lock can be produced for maintaining a door in a deadbolt unlocked or locked position under no power.

To allow the DPLS to be power versatile requires that the current through the control coil(s) be pulsed activated to cause the movement of the moveable central core to occur over a short time duration. This can be accomplished using a capacitively pulsed power system, such that the time the that the majority of the current is applied to the control coil(s) in the DPLS is mostly controlled by the stored energy in a capacitor, where shorting of the pulse time duration can be further controlled with a control circuit. One such mean specially design for the DPLS is the bi-stable permanent magnet actuator system (BSPMAS) of U.S. Pat. No. 9,343,216, which includes a power source, voltage conditioner, an energy storage capacitor, and a control circuit that controls electronic switches to activates the current to the DPLS in alternating directions. The control circuit can be a wireless controlled microcomputer or module for activation of the current to the DPLS. The wireless controlled module can be designed to connect to various wireless means, as smart-phones or wireless networks, Bluetooth devices or RF control devices.

It has been demonstrated for a DPLS with the power requirement needed in the present invention that the voltage conditioner in the BSPMAS can be a DC-DC boost powered from a 5V-USB or 5V directly from a computer to allow the present invention to be easily merge into a home or building's energy management system. Given the low voltage (i.e. 5V), the BSPMAS can be powered using prior art wireless charging station technology across the gap between the door and frame. The wireless charging station would then provide the energy to charge a battery or capacitor to power the BSPMAS to control the DPLS in the present invention and place a plunger in a deadbolt locked or unlock position.

### BRIEF DESCRIPTION OF THE DRAWINGS

In the following, the invention is described in more detail by reference to the enclosed drawings, where

FIG. 1 shows an illustration of one embodiment of the electric door lock of the present invention to show the various components; showing the deadbolt plunger in the locked position;

FIG. 2 shows an illustration of the electric door locking body of the present invention with the deadbolt plunger in the unlocked position;

FIG. 3 shows an illustration of the two-different magnetic latching positions of the preferred DPLS used in the door locking body of FIG. 2 with the moveable magnetic core shown in the rightward latching position in FIG. 3a and in the leftward latching position in FIG. 3b;

FIG. 4 shows an illustration of the frame locking mechanism of the present invention to secure the plunger from the electric deadbolt door lock body of FIG. 2 in the frame;

FIG. 5 shows an illustration of the electric deadbolt door lock body of FIG. 2 with the addition of a mechanical release/locking device; showing the deadbolt plunger in the locked position;

FIG. 6 shows an illustration of one wireless charger station that can be used in the present invention across the door/frame gap;

FIG. 7 shows an illustration of a BSPMAS with a wireless control module that can be used in the present invention for wireless control of the DPLS of FIG. 3;

FIG. 8 shows an illustration of optional lock/unlock mechanical switches that can be added to the BSPMAS of FIG. 7 to bypass the activation switches in the BSPMAS to lock/unlock the present invention when a wireless device is unavailable; and

FIG. 9 shows an illustration of optional switches that can be added to the BSPMAS of FIG. 7 to allow the DPLS in the door locking body of FIG. 2 to be operated by a portable BSPMAS device to lock/unlock the present invention for testing or when power to the deadbolt door lock is unavailable.

### DETAILED DESCRIPTION

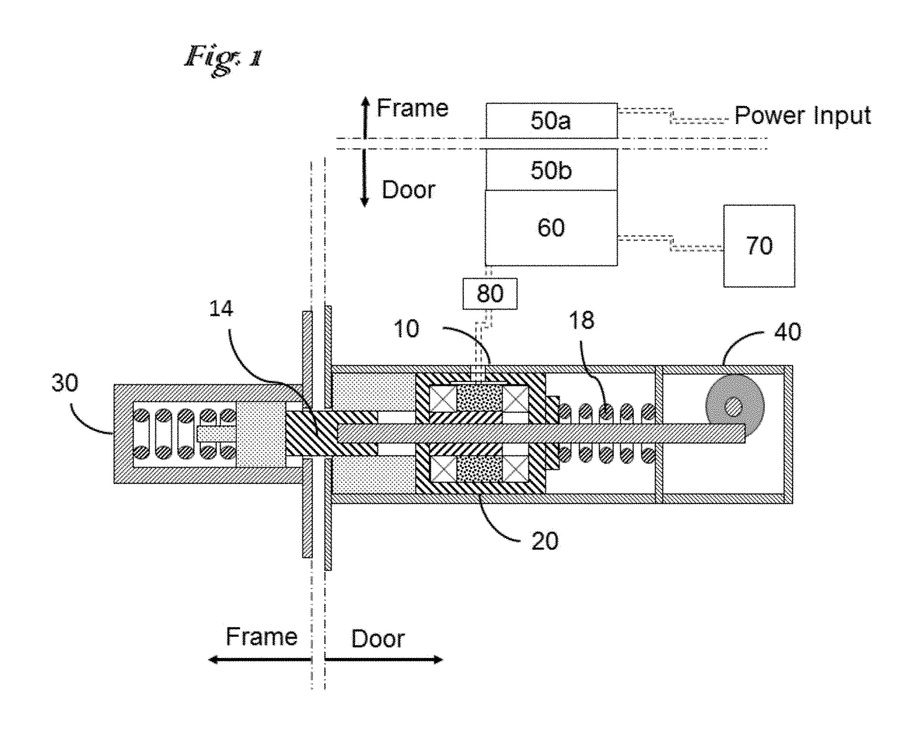

Referring to FIGS. 1-9, which are shown to facilitate the features of the present invention.

FIG. 1 is a drawing of one embodiment of an electric door lock to illustrate the components of the present invention; comprising an electric door locking body 10 containing a DPLS 20 to push/pull a deadbolt plunger 14, a frame locking mechanism 30 to secure the deadbolt plunger 14 of the electric deadbolt door lock body 10 in the deadbolt locking position (as shown and with the door locking spring 18 in the uncompressed position), a mechanical release/locking device 40, a wireless charging station 50 composed of a transmitter portion 50a and a receiver portion 50b, a wireless controlled BSPMAS 60, optional lock/unlock electrical mechanical switches 70 and optional switches 80 for connecting a portable BSPMAS.

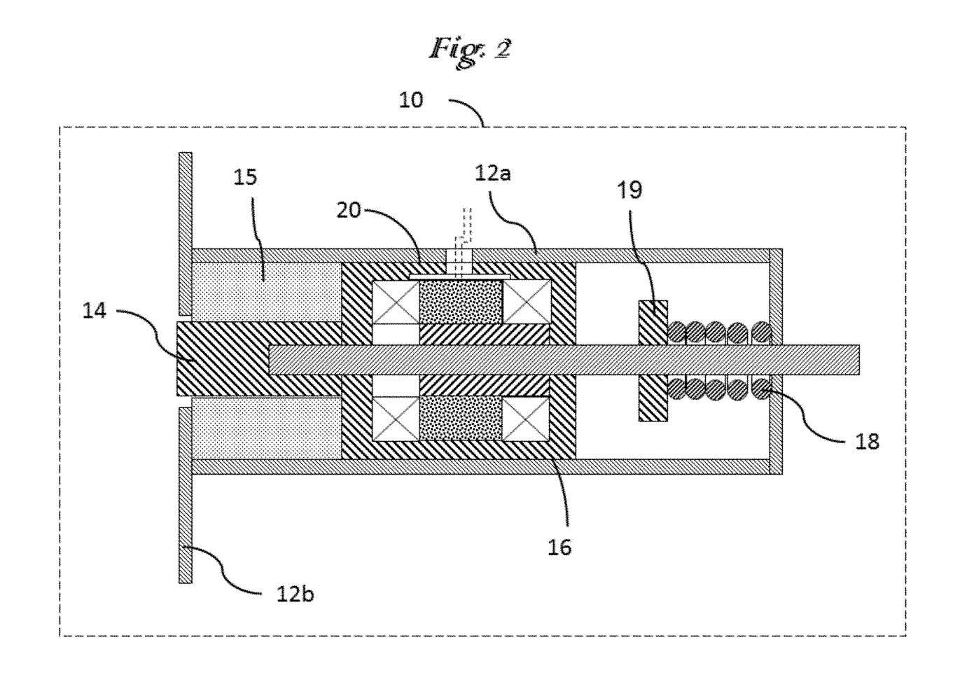

In FIG. 1, the receiver 50b and BSPMAS 60 are shown as an integrated unit. Throughout the FIGS. 1-9, the crooked dash lines represent power or control lines. In FIGS. 2, 4, and 7, the dashed boxes represent a collection of components.

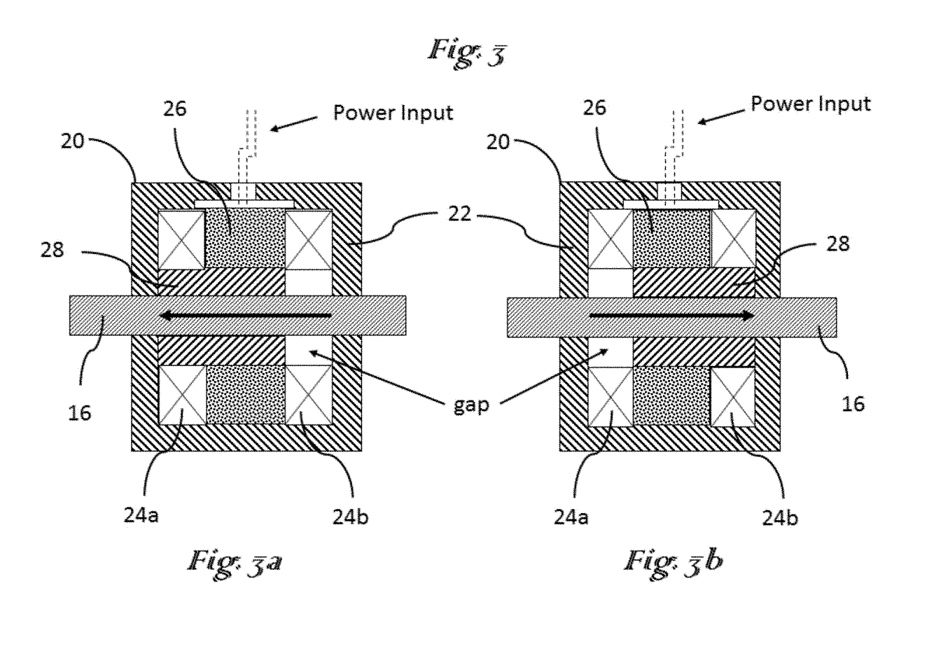

FIG. 2 is a drawing to illustrate the electric deadbolt door lock body 10 of the present invention, comprising a housing 12a and 12b, a deadbolt plunger 14 shown in the unlocked deadbolt position, a plunger guide/spacer 15, a shaft 16, a door locking spring 18 shown in the compressed position, a spring compressor 19, and a DPLS 20. In FIG. 2, the housing 12b is firmly attached to the housing 12a and affixes to the door as in prior art door locks; housing 12a and 12b contain the deadbolt plunger 14, plunger guide/spacer 15, shaft 16, door locking spring 18, spring compressor 19, and DPLS 20; the shaft 16 is free to move through the end of the housing 12a and the deadbolt plunger 14 is free to move through the housing 12b; the deadbolt plunger 14 is free to move though the plunger guide/spacer 15; the spring compressor 19 is firmly attached to the shaft 16 to compress or allow decompression of the door locking spring 18 as the shaft 16 moves; and the shaft 16 moves with the operation of the DPLS 20 as shown in FIG. 3.

In FIG. 2, provision for keeping the plunger guide/spacer 15 from leaving the inside of the electric door locking body 10 is done by extending the housing 12b. It is understood that other provisions for keeping the plunger guide/spacer 15 from leaving the inside of the electric deadbolt door lock body 10 can be done without taken from the intent of the present invention.

It is understood that the electric deadbolt door lock body 10 of FIG. 2 does not need the door locking spring 18 and the spring compressor 19 to function when the magnetic force of the DPLS is higher than the resistive forces on the shaft 16, deadbolt plunger 14, and moveable magnetic core 28.

FIG. 3 is a drawing to illustrate one version of a DPLS 20 that can be used in the electric deadbolt door lock body 10 of FIG. 2, comprising a magnetic housing 22, control coils 24a and 24b, permanent magnet 26, and moveable magnetic core 28, where the shaft 16 of FIG. 2 is firming attached to the moveable magnetic core 28. In FIG. 3a, the moveable magnetic core 28 is magnetically latched to the left end of the magnetic housing 22, having moved the shaft 16 to the left as indicated by the arrow. In FIG. 3a, the moveable magnetic core 28 is magnetically latched to the right end of the magnetic housing 22, having moved the shaft 16 to the right as indicated by the arrow.

It is understood that in FIG. 3 the “gap” provides the movement distance of the moveable magnetic core 28 and should be matched to the expected movement distance of the deadbolt plunger 14 of FIG. 1.

In FIG. 3, the DPLS 20 is similar to U.S. Pat. No. 3,022,450 with the coils 24a-b composed of multiple coils for use with the BSPMAS 60 in the present invention, as is discussed in U.S. Pat. No. 9,343,216.

As shown in FIG. 3, provision for the “Power Input” to the control coils are provided in a central top location. It is understood that other provisions for the power lines in different locations can be done without taken from the intent of the present invention.

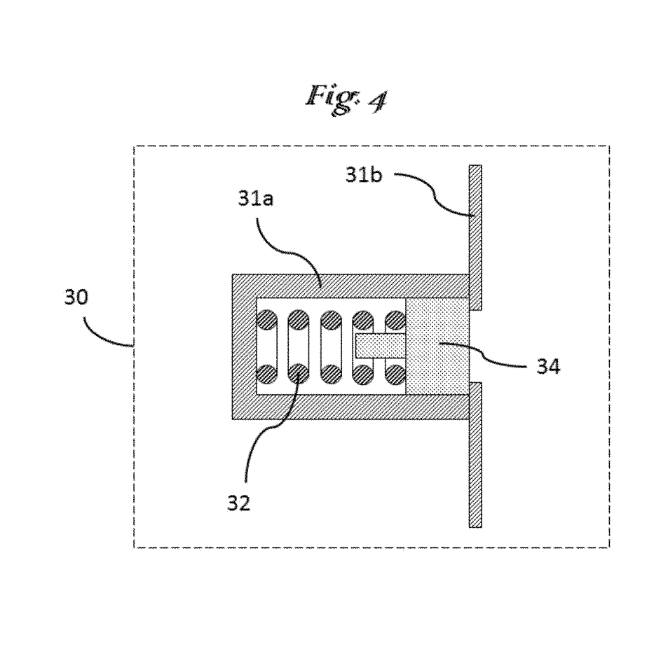

FIG. 4 is a drawing to illustrate the frame locking mechanism 30 of the present invention, comprising a housing 31a and 31b, a frame locking spring 32, and a frame locking plunger 34 having a portion extruding into the spring for alignment. In FIG. 4, provision for keeping the frame locking plunger 34 from leaving the inside of the frame locking mechanism 30 is done by extending the housing portion 31b; the motion of the frame locking spring 32 and the frame locking plunger 34 allow for differences in the movement distance of the deadbolt plunger 14 in FIG. 1 due to differences in door/frame assemblies to assure that the moveable magnetic core 28 of FIG. 3 firmly latches to the housing 22 of FIG. 3.

It is understood that other provisions for keeping the frame locking plunger 34 from leaving the inside of the frame locking mechanism 30 can be done without taken from the intent of the present invention.

It is understood that the door locking spring 18 in FIG. 2 and the frame locking spring 32 in FIG. 4 provide a mating force pair to overcome motion fiction in the present invention, and to help move the moveable magnetic core 28 of FIG. 3 to move across the “gap” of FIG. 3, where the door locking spring 18 and frame locking spring 32 exchange stored energies and attain stored energy from the magnetic force on the moveable magnetic core 28 of the DPLS of FIG. 3.

In reference to FIGS. 1-4 with the moveable magnetic core 28 in the position shown in FIG. 3a, when a current is applied to a first control coil 24a or 24b in the DPLS 20 of FIG. 3 to cause the magnetic flux from the permanent magnet 26 to be directed toward the right side of the magnetic housing 22, the moveable magnetic core 28 will be magnetically attracted to the right side of the magnetic housing 22. Whereby, the moveable magnetic core 28 moves (with the aid of the spring force from the frame locking spring 32 on the frame locking plunger 34 in the frame locking mechanism 30) from the position in FIG. 3a to the position in FIG. 3b, carrying the shaft 16 with it, placing the deadbolt plunger 14 in the electric deadbolt door lock body 10 from the position in FIG. 1 to the position in FIG. 2. Whereby, the deadbolt plunger 14 is pulled out of the frame locking mechanism 30 allowing the frame locking spring 32 to decompress by pushing the frame locking plunger 34 from the position in FIG. 1 to the position in FIG. 4, and the movement of the spring compressor 19 with the shaft 16 compresses the door locking spring 18 as shown in FIG. 2; placing the present invention in an unlocked deadbolt position.

Reversely, with the moveable magnetic core 28 in the position shown in FIG. 3b, when a current is applied to a second control coil 24b or 24a in the DPLS 20 of FIG. 3 to cause the magnetic flux from the permanent magnet 26 to be directed toward the left side of the magnetic housing 22, the moveable magnetic core 28 will be magnetically attracted to the left side of the magnetic housing 22. Whereby, the moveable magnetic core 28 moves (with the aid of the spring force of door locking spring 18 on the spring compressor 19) from the position in FIG. 3b to the position in FIG. 3a, carrying the shaft 16 with it, placing the deadbolt plunger 14 in the electric deadbolt door lock body 10 from the position in FIG. 2 to the position in FIG. 1. Whereby, the deadbolt plunger 14 is pushed into the frame locking mechanism 30 against the frame locking plunger 34 to compress the frame locking spring 32 by moving the frame locking plunger 34 from the position in FIG. 4 to the position in FIG. 2, and the movement of the spring compressor 19 with the shaft 16 allows the door locking spring 18 to decompress as shown in FIG. 1, placing the present invention in a locked deadbolt position.

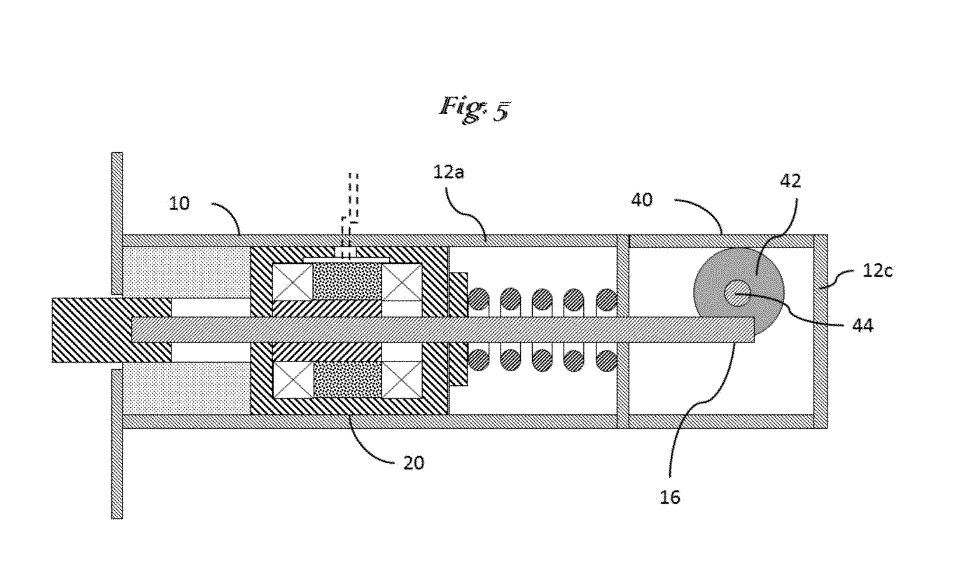

FIG. 5 is a drawing to illustrate one embodiment of the mechanical release/locking device 40 that can be used in the present invention, comprising a housing 12c firmly attached to the housing 12a of the electric door locking body 10, a force member 42, and a pivot portion 44 that is firmly attached to the force member 42. The pivot portion 44 is attached (not shown) to the housing 12c in a manner that allows it to freely rotate and the force member 42 is attached (not shown) to the shaft 16 in a manner that pulls or pushes the shaft 16 when the force member 42 is rotated.

It is understood that other mechanical release/locking mechanism can be used without taken from the intent of the present invention.

In reference to FIGS. 1-5, and when a levering force, say from a lever type door handle attached to the pivot portion 44, causes the force member 42 to rotate in one direction, the shaft 16 is pulled outward toward the mechanical release/locking device 40 to pull the moveable magnetic core 28 in the DPLS 20 of FIG. 3 (with the aid of the spring force from the frame locking spring 32 on the frame locking plunger 34 in the frame locking mechanism 30) from the position shown in FIG. 3a to the position in FIG. 3b, placing the deadbolt plunger 14 in the electric deadbolt door lock body 10 from the position in FIG. 1 to the position in FIG. 2. Whereby, the deadbolt plunger 14 is pulled out of the frame locking mechanism 30 allowing the frame locking spring 32 to decompress by pushing the frame locking plunger 34 from the position in FIG. 1 to the position in FIG. 4, placing the present invention in an unlocked deadbolt position. Resulting in the compression of the door locking spring 18 in FIG. 2.

Reversely, when the levering force causes the force member 42 to rotate in the reverse direction, the shaft 16 is pushed inward toward the mechanical release/locking device 40 to push the moveable magnetic core 28 in the DPLS 20 of FIG. 3 (with the aid of the spring force from the door locking spring 18 on the spring compressor 19) from the position shown in FIG. 3b to the position in FIG. 3a, placing the deadbolt plunger 14 in the electric deadbolt door lock body 10 from the position in FIG. 2 to the position in FIG. 1. Whereby, the deadbolt plunger 14 is pushed into the frame locking mechanism 30 against the frame locking plunger 34 to compress the frame locking spring 32 by moving the frame locking plunger 34 from the position in FIG. 4 to the position in FIG. 2, placing the present invention in a locked deadbolt position. Resulting in the decompression of the door locking spring 18 in FIG. 2.

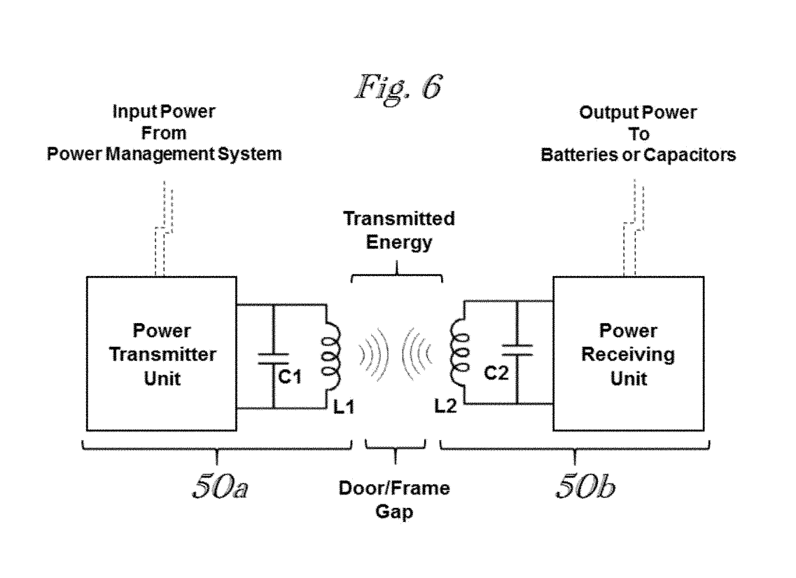

FIG. 6 illustrates one wireless charging station 50 known in the art of wireless power charging that can be used in the present invention to wirelessly charge batteries or capacitors for operation of the present invention. The wireless charging station 50 shown is an inductive charger (also known as wireless charging or cordless charging) as is known in the art of wireless power charging. The wireless charging station 50 is composed of a transmitter 50a and receiver 50b, which uses an electromagnetic field to transmit energy between the transmitter 50a and receiver 50b through electromagnetic induction. Whereby, they form a wireless charging station, when the door is closed.

In FIG. 6, the transmitter 50a attains “Input Power” from the “Power Management System” of the home or building, which could simply be a power outlet. The power goes to a “Power Transmitter Unit” coupled to a capacitor C1 and an inductor L1, which transmits energy outward. In FIG. 6, the receiver 50b has a “Power Receiving Unit” coupled to a capacitor C2 and an inductor L2, which receives the “Transmitted Energy” from the inductor L1 across the “Door/Frame Gap”. The “Power Receiving Unit” conditions the attained energy to the proper voltage needed to charge the batteries or capacitors in the present invention.

It is understood that capacitors, especially supercapacitors, will be better suited for the present invention as batteries may need periodic changed.

It is understood that other wireless power systems maybe used without taken from the intent of the present invention.

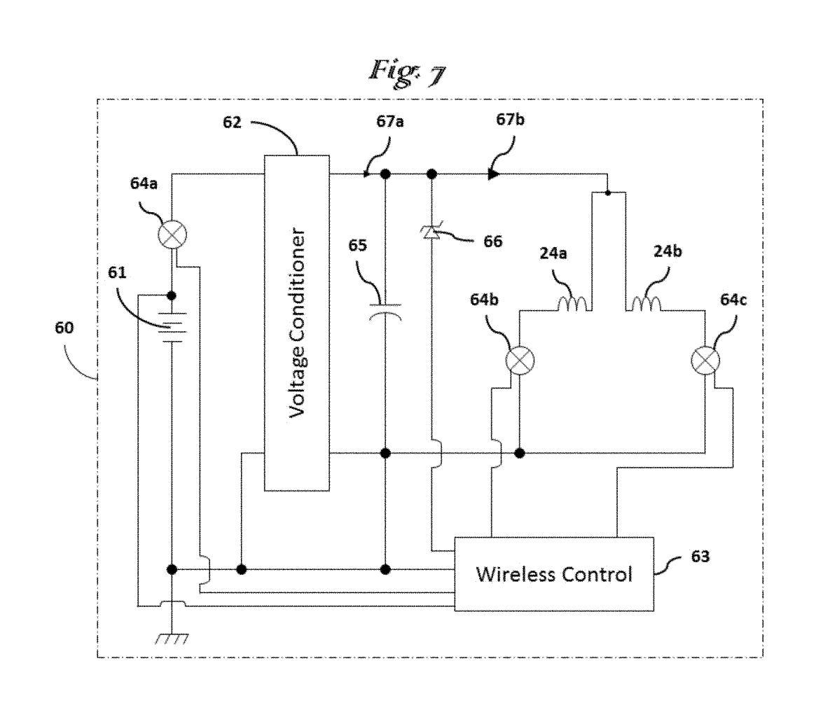

FIG. 7 illustrates a modification of FIG. 2 from the Energy Efficient Bi-Stable Permanent Magnet Actuation System (BSPMAS 60) of U.S. Pat. No. # 9,343,216 for operation of the DPLS 20 in the present invention, comprising: a power source 61, which is the battery or capacitor being charged by the wireless charging station 50 in FIG. 6; a voltage conditioner 62; a wireless control module 63; three switches 64a-c; a capacitor 65; and a voltage sensor 66.

Operation of the BSPMAS 60 of FIG. 7 begins by closing power source switch 64a by wireless control module 63 to allow power from the power source 61 to inner the voltage conditioner 62. The voltage conditioner 62 conditions the voltage of the power source and passages a low current 67a to the storage capacitor 65 until the operation voltage of the DPLS 20 is reached. That is, the voltage on the capacitor 65 will rise with charge from the voltage conditioner 62 until the wireless control module 63 senses the operation voltage through sensor 66. When the wireless control module 63 receives an input from an operator, by means of an outside wireless device, one of the switches 64b or 64c is activated to send a pulsed current 67b to one of the control coils 24a or 24b of the DPLS 20 of FIG. 3 to either lock or unlock the electric deadbolt door lock.

It is understood that the outside wireless device can be any wireless device that can communicate with the wireless control module 63.

It is understood that the switch 64a may not be needed when the BSPMAS 60 is design for very low or zero power drain between operations.

It is understood that the home or building's power management system may contain a wireless control module that can talk to the wireless control 63 of the present invention to periodically turn off the power to the transmitter 50a when the wireless control 63 of the present invention indicates that the batteries or capacitors are fully charged.

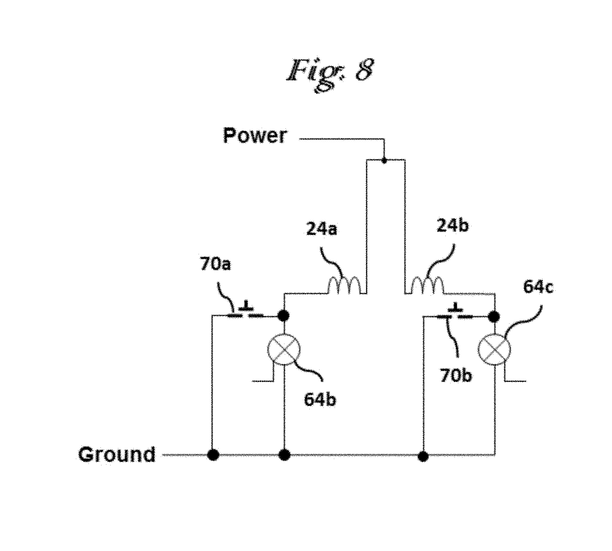

FIG. 8 illustrates optional lock/unlock mechanical switches 70a and 70b, where FIG. 8 is a portion of FIG. 7 to show the placement of the mechanisms 70a and 70b. As shown, mechanical switch 70a allow the switch 64b to be bypassed and mechanical switch 70b allow the switch 64c to be bypassed.

It is understood that the switches 70a and 70b should be momentary switches to prevent excessive power loss and be on the inside of the door to allow lock or release of the deadbolt when a wireless device is unavailable.

It is understood that similar mechanical switches 70a and 70b can be placed on the outside of the door if used with a security method (key or etc.) to prevent unwanted entry.

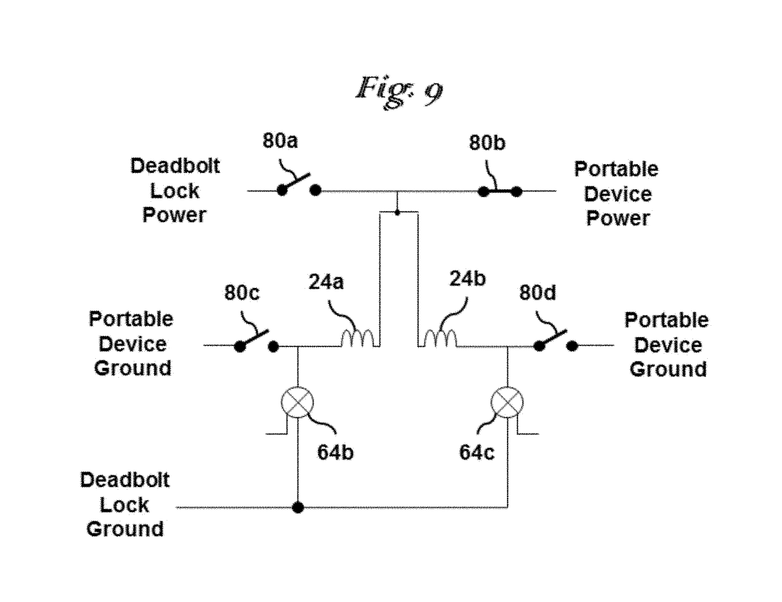

FIG. 9 illustrates optional switches for operating the DPLS with a portable device containing a BSPMAS 60 similar to that shown FIG. 7, where FIG. 9 is a portion of FIG.7 to show the placement of the switches 80a-d, where switches 80c-d act like switches 64b-c to provide current flow through the control coils 24a-b to the ground in the portable device. In FIG. 9, the connection to switches 80a-d must be such that the switch 80a is opened to turned off the deadbolt lock power to prevent charging or discharging of the capacitor 65 in FIG. 7, the switch 80b is closed to provide power from the portable device. It is understood that the switches 80a-d could be access through one of more electrical connector on the door.

The invention claimed is:

1. An electric deadbolt door locking system that does not need continuous power to maintain a deadbolt in a locked or unlocked position between activations, comprising:
an electric deadbolt door lock body containing:
a housing for attaching to a door and containing the various components that produce the deadbolt positions of locking and unlocking; these components being;
a Dual Position Latching Solenoid (DPLS), firmly attached to said housing of said electric deadbolt door lock body, having a magnetic housing, movable magnetic core, one or more control coils, and a permanent magnet;
a shaft firmly connected to the said movable magnetic core of said DPLS, free to move through said magnetic housing of said DPLS and a first end of the said housing of said electric deadbolt door lock body, said first end being opposite to a second end of said housing of said electric deadbolt door lock body that is attached to the door; and
a deadbolt plunger firmly connected to said shaft and free to move through said second end of the said housing of said electric deadbolt door lock body; where when said deadbolt plunger is in said housing of said electric deadbolt door lock body, said deadbolt plunger is in the deadbolt unlocked position, and when the deadbolt plunger is extruding out of said housing of said electric deadbolt door lock body, said deadbolt plunger is in the deadbolt locked position;
a pulsed capacitor power and control method for sending an alternating pulsed current to said control coil of said DPLS to activate said DPLS and cause movement of said movable magnetic core of said DPLS in a linear reciprocating manner;
and a power input method from an input power system to provide power to said pulsed capacitor power and control method to activate said DPLS;
when said power input method is providing power to said pulsed capacitor power and control method and said deadbolt plunger is in said deadbolt unlocked position, and when said pulsed capacitor power and control method sends a pulsed current to said one or more control coils of said DPLS in a first direction, the magnetic flux of said permanent magnet of said DPLS is directed through said movable magnetic core of said DPLS toward a first end of said magnetic housing of said DPLS to produce a magnetic force to cause said movable magnetic core of said DPLS to move toward and magnetically latch to said first end of said magnetic housing of said DPLS; carrying said shaft and said deadbolt plunger with said movable magnetic core of said DPLS to cause said deadbolt plunger to move outward from said housing of said electric deadbolt door lock body; placing said deadbolt plunger in said deadbolt locked position;
when said power input method is providing power to said pulsed capacitor power and control method and said deadbolt plunger is in said deadbolt locked position, and when said pulsed capacitor power and control method sends a pulsed current to said one or more control coils of said DPLS in a second direction, the magnetic flux of said permanent magnet of said DPLS is directed through said movable magnetic core of said DPLS toward a second end of said magnetic housing of said DPLS to produce a magnetic force to cause said movable magnetic core of said DPLS to move toward and magnetically latch to said second end of said magnetic housing of said DPLS; carrying said shaft and said deadbolt plunger with said movable magnetic core of said DPLS to cause said deadbolt plunger to move into said housing of said electric deadbolt door lock body; placing said deadbolt plunger in said deadbolt unlocked position;
thus to produce an electric deadbolt door locking system that does not need continuous power to maintain said deadbolt plunger in a deadbolt locked or unlocked position between activations of said DPLS.

2. An electric deadbolt door lock that does not need continuous power to maintain a door in the deadbolt locked or unlocked position between activation, comprising:
an electric deadbolt door lock body containing:
a housing for attaching to a door and containing the various components that produce the deadbolt positions of locking and unlocking; these components being;
a Dual Position Latching Solenoid (DPLS), firmly attached to said housing of said electric deadbolt door lock body, having a magnetic housing, movable magnetic core, one or more control coils, and a permanent magnet,
a shaft firmly connected to the said movable magnetic core of said DPLS, free to move through said magnetic housing of said DPLS and a first end of the said housing of said electric deadbolt door lock body, said first end being opposite to a second end of said housing of said electric deadbolt door lock body that is attached to the door;
a deadbolt plunger firmly connected to said shaft and free to move through said second end of the said housing of said electric deadbolt door lock body; where when said deadbolt plunger is in said housing of said electric deadbolt door lock body, said deadbolt plunger is in the deadbolt unlocked position, and when the deadbolt plunger is extruding out of said housing of said electric deadbolt door lock body, said deadbolt plunger is in the deadbolt locked position;
a spring compressor firmly attached to said shaft outside said DPLS opposite to said deadbolt plunger and free to move inside said housing of said electric door locking body; and
a door locking spring about the shaft between said spring compressor and the inside of said first end of said housing of said electric door locking body;
a frame locking mechanism comprising:
a housing for attaching to a door frame and containing:
a frame locking plunger free to move in, but prohibited from leaving, the inside of said housing of said frame locking mechanism; and
a frame locking spring that is compressed or decompressed by the movement of said frame locking plunger between said frame locking plunger and said inside of said housing of said frame locking mechanism;
a pulsed capacitor power and control method for sending an alternating pulsed current to said one or more control coils of said DPLS to cause movement of said movable magnetic core of said DPLS in a linear reciprocating manner;
and a power input method from an input power system to provide power to said pulsed capacitor power and control method;
when said power input method is providing power to said pulsed capacitor power and control method with said deadbolt plunger of said electric door lock in said deadbolt unlocked position, where said door locking spring is compressed by said spring compressor, and when said pulsed capacitor power and control method sends a pulsed current to said one or more control coils of said DPLS in a first direction, the magnetic flux of said permanent magnet of said DPLS is directed through said movable magnetic core of said DPLS toward a first end of said magnetic housing of said DPLS to produce a magnetic force to cause said movable magnetic core of said DPLS to move with aid of the spring force from said door locking spring toward and magnetically latch to said first end of said housing of said DPLS; carrying said shaft and said deadbolt plunger with said movable magnetic core of said DPLS to cause said plunger to move outward from said housing of said electric deadbolt door lock body and into said frame locking mechanism against said frame locking plunger to move said frame locking plunger from a first to second position, and compressing said frame locking spring while decompressing said door locking spring through movement of said spring compressor with said shaft and said movable magnetic core of said DPLS; placing said electric deadbolt door lock in said deadbolt locked position;
when said power input method is providing power to said pulsed capacitor power and control method with said deadbolt plunger of said electric door lock in said deadbolt locked position, where said frame locking spring is compressed by said frame locking plunger by said deadbolt plunger, and when said pulsed capacitor power and control method sends a pulsed current to said one or more control coils of said DPLS in a second direction, the magnetic flux of said permanent magnet of said DPLS is directed through said movable magnetic core of said DPLS toward a second end of said magnetic housing of said DPLS to produce a magnetic force to cause said movable magnetic core of said DPLS to move with aid of the spring force from said frame locking spring toward and magnetically latch to said second end of said magnetic housing of said DPLS; carrying said shaft and said deadbolt plunger with said movable magnetic core of said DPLS to cause said deadbolt plunger to move outward from said frame locking mechanism and into said housing of the electric door lock body, causing said frame locking spring to decompress and moving said frame locking plunger from said second to said first position, and compressing said door locking spring by said spring compressor with movement of said shaft and said movable magnetic core of said DPLS; placing the said electric deadbolt door lock in said deadbolt unlocked position;
thus to produce an electric deadbolt door lock that does not need continuous power to maintain a door in a deadbolt locked or unlocked position between activation of said DPLS.

3. The electric deadbolt door locking system of claim 1, wherein a plunger guide/spacer is added between said DPLS and the inside of said second end of said housing of said electric deadbolt door lock body and prohibited from leaving the inside of said housing of said electric deadbolt door lock body, to aid in the alignment of the said deadbolt plunger's movement outward of the said housing of said electric deadbolt door lock body.

4. The electric deadbolt door lock of claim 2, wherein a plunger guide/spacer is added between said DPLS and the inside of said second end of said housing of said electric deadbolt door lock body and prohibited from leaving the inside of said housing of said electric deadbolt door lock body, to aid in the alignment of the said deadbolt plunger's movement outward of the said housing of said electric deadbolt door lock body and into said frame locking mechanism.

5. The electric deadbolt door locking system of claim 1, wherein said pulsed capacitor power and control method is a modification of the BSPMAS in U.S. Pat. No. 9,343,216.

6. The electric deadbolt door lock of claim 2, wherein said pulsed capacitor power and control method is a modification of the BSPMAS in U.S. Pat. No. 9,343,216.

7. The electric deadbolt door locking system of claim 1, wherein said pulsed capacitor power and control method contains a wireless control module.

8. The electric deadbolt door lock of claim 2, wherein said pulsed capacitor power and control method contains a wireless control module.

9. The electric deadbolt door locking system of claim 1, wherein said power input method is a wireless charging station to charge one or more batteries or capacitors to power said pulsed capacitor power and control method.

10. The electric deadbolt door lock of claim 2, wherein said power input method is a wireless charging station when the door is closed with a transmitter in the door frame and a receiver in the door to charge one or more batteries or capacitors to power said pulsed capacitor power and control method.

11. The electric deadbolt door locking system of claim 1, wherein said pulsed capacitor power and control method contains electrical mechanical switches for placing said deadbolt plunger in a locked or unlocked deadbolt position.

12. The electric deadbolt door lock of claim 2, wherein said pulsed capacitor power and control method contains electrical mechanical switches on the inside of the door for placing said deadbolt plunger in a locked or unlocked deadbolt position.

13. The electric deadbolt door lock of claim 2, wherein said pulsed capacitor power and control method contains electrical mechanical switches on the outside of the door for placing said deadbolt plunger in a locked or unlocked deadbolt position, where said electrical mechanical switches are behind a security lock to prevent unwanted entry.

14. The electric deadbolt door locking system of claim 1, wherein electrical switches are provided to bypass said pulsed capacitor power and control method to activate said DPLS with a portable pulsed capacitor power and control method in a portable device to place said deadbolt plunger in a locked or unlocked deadbolt position for testing or when power to said pulsed capacitor power and control method is unavailable.

15. The electric deadbolt door lock of claim 2, wherein electrical switches are provided to bypass said pulsed capacitor power and control method to activate said DPLS with a portable pulsed capacitor power and control method in a portable device to place said deadbolt plunger in a locked or unlocked deadbolt position for testing or when power to said pulsed capacitor power and control method is unavailable.
